(19) United States
(12) Patent Application Publication
(10) Pub. No.: US 2015/0046206 A1
(43) Pub. Date: Feb. 12, 2015

(54) Method, Apparatus, and System for Managing Work Flow

(71) Applicant: Jordan Kelley, Las Vegas, NV (US)

(72) Inventor: Jordan Kelley, Las Vegas, NV (US)

(21) Appl. No.: 13/964,193

(22) Filed: Aug. 12, 2013

(51) Int. Cl. G06Q 10/06; G06Q 30/04

(52) U.S. Cl. CPC G06Q 10/06311; G06Q 30/04
USPC 705/7.13

(57) ABSTRACT

A method, apparatus, system and media for managing work flow. One embodiment comprises a processor-readable media having processor-executable instructions stored thereon, comprising instructions to receive a service request from the customer via a user interface on the wireless communication device, the service request comprising a type of service desired by the customer, instructions for transmitting the service request by a communication interface in the wireless communication device to a central server, the central server for providing an invitation, based on the service request, to service providers that are pre-authorized by a central authority entity and who offer services matching the type of service identified in the service request, and instructions for a receiver in the wireless communication device to receive an acceptance of the service request from the central server, the acceptance provided by one of the pre-authorized service providers that received the invitation to the central server.

### CLAIM OF PRIORITY

This application is a continuation of, and claims priority to, U.S. Provisional Patent Application No. 61/826,083, filed on May 22, 2013, owned by the inventor of the present application and incorporated by reference herein in its entirety.

### BACKGROUND

I. Field of Use

The present application relates generally the management of work flow, and more specifically to a system, apparatus, and method for managing a process of hiring and tracking of service personal for any variety of needs, as explained in greater detail herein.

II. Description of the Related Art

In the past, when home or business owners needed the services of a handyman or other type of service requiring on-site visits by service personnel, they might consult the Yellow Pages or, more recently, websites such as Yelp.com, Angieslist.com or Craigslist.com in an attempt to find a qualified service person to perform the service. Many of these websites rate past customer experiences with each service person or organization so that other customers may gain a sense of the expected quality and/or price of the services offered by a particular individual/organization. Unfortunately, many of these ratings are submitted by service individuals/organizations themselves, in an attempt to appear more qualified and/or less expensive than competing individuals/organizations.

After a service provider is chosen, a customer generally places a telephone call or email to see if the selected service provider is willing and able to perform the service needed by the customer, and a time that is mutually convenient to both parties. Often, this process extends for a great deal of time, as the service provider may not answer the call from the customer for whatever reason, or an email might not be received by the service personal for some time after transmission by the customer.

After services have been agreed to between the customer and a service provider, the service provider arrives at the customer's location and assesses the service requirements. Often, the service provider must then leave the work site in order to procure the necessary parts to complete the service request. Often times, the service provider is gone for a long time period, leaving the customer wondering where the services provider is, when the service provider will return, and whether the requested service will be completed on time.

After returning from retrieving the necessary parts, the service provider performs the requested service for the customer and generally provides a written bill to the customer. The customer, in turn, will generally provide cash or a check to the service provider. In return, the service provider generally provides a receipt to the customer. The service provider must generally go back to the service provider's work location to enter information about the service that was just provided into a computer so that an accounting of the service provider's time and payment can be tracked by an accounting program.

The customer may want to provide feedback as to the quality and value that was given by the service provider. The customer must generally use a smartphone or computer, look up the service provider rating website, and enter information pertaining to the customer's experience with the service provider.

All of the above steps are time-consuming and inefficient for both the consumer and the service provider. What is needed is a system, method, and apparatus that makes the entire process of hiring, servicing, and post-service activities more efficient and convenient for both customers and service providers.

### SUMMARY

The embodiments described herein relate to methods, a system, apparatus, and processor-readable media for managing work flow in a network of service providers and customers.

In one embodiment, a processor-readable media is described having processor-executable instructions stored thereon for execution by a processor to perform a method for managing work flow for a customer using a wireless communication device, comprising, instructions for the processor to receive a service request from the customer via a user interface on the wireless communication device, the service request comprising a type of service desired by the customer, instructions for transmitting the service request by a communication interface in the wireless communication device to a central server, the central server for providing an invitation, based on the service request, to service providers that are pre-authorized by a central authority entity and who offer services matching the type of service identified in the service request, and instructions for a receiver in the wireless communication device to receive an acceptance of the service request from the central server, the acceptance provided by one of the pre-authorized service providers that received the invitation to the central server.

In another embodiment, a processor-readable medium is described having processor-executable instructions stored thereon for execution by a processor to perform a method for managing work flow for a pre-authorized service provider using a wireless communication device, comprising, instruction for a communication interface in the wireless communication device to receive an invitation from a central server to provide a service requested by a customer, instructions for a user interface on the wireless communication device to display the invitation to the service provider, instructions for the processor to receive an indication of acceptance of the invitation from the service provider via a user interface, instructions for the communication interface to transmit a response to the invitation accepting the invitation, instructions for the processor to receive service material procurement information from the service provider, via the user interface, the material procurement information comprising a description and a cost of one or more items needed to perform the service, instructions for the processor to store the material procurement information in a memory, instructions for the processor to calculate a time that the service provider spent performing the service, instructions for the processor to calculate an electronic invoice using the time that the service provider spent performing the service and the cost of each of the one or more items needed to perform the service, and instructions for the communication interface to transmit the invoice to the central server for ultimate presentation of the invoice to the customer who requested the service via a customer wireless communication device.

In yet another embodiment, a central server is described for managing work flow between a customer using a customer wireless communication device and a pre-authorized service provider using a service provider wireless communication device, comprising, a network interface for transmitting to and receiving information from the customer and the service provider, a memory for storing account information associated with the customer and the pre-authorized service provider and for storing processor-executable instructions, a processor for executing the processor-executable instructions that cause the central server to receive a service request from the customer, generate an invitation to provide a service to the customer based on the service request, send the invitation to one or more pre-authorized service providers, including the pre-authorized service provider, each of the pre-authorized service providers previously having registered with the central server, receive an acceptance to the invitation from the pre-authorized service provider, receive invoice information from the service provider after the service has been completed, and provide the invoice information to the customer after the service provider has provided the service to the customer.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is an illustration of one embodiment of a system for managing work flow relating to a service provider network;

FIG. 2 is a functional block diagram of one embodiment of either a customer wireless communication device or service provider wireless communication device, as shown in FIG. 1;

FIG. 3 illustrates a functional block diagram of one embodiment of the server shown in FIG. 1;

FIG. 4 is a flow diagram illustrating one embodiment of a method for managing work flow between a customer and a service provider as performed by a customer application running on the customer mobile communication device shown in FIG. 1;

FIG. 5 is a flow diagram illustrating one embodiment of a method for managing work flow between a customer and a service provider as performed by a service provider application running on the service provider mobile communication device shown in FIG. 1; and

FIG. 6 is a flow diagram illustrating one embodiment of a method for managing work flow between a customer and a service provider as performed by the server shown in FIG. 1.

### DETAILED DESCRIPTION

The present disclosure relates to a system, method, and apparatus for managing work flow. The term “work flow” may refer to a service that is performed by a “service provider”, e.g., any individual or organization that performs services for a fee. Services are requested by individuals or businesses when a need arises for a repair or other services. For example, individuals may desire the services of a general handyman to effect home repairs, or a more specialized service provider that specializes in a particular trade, such as electrical, plumbing, HVAC, computer setup and/or repair, roofing, pool construction or maintenance, etc. The type and number of service providers is almost unlimited.

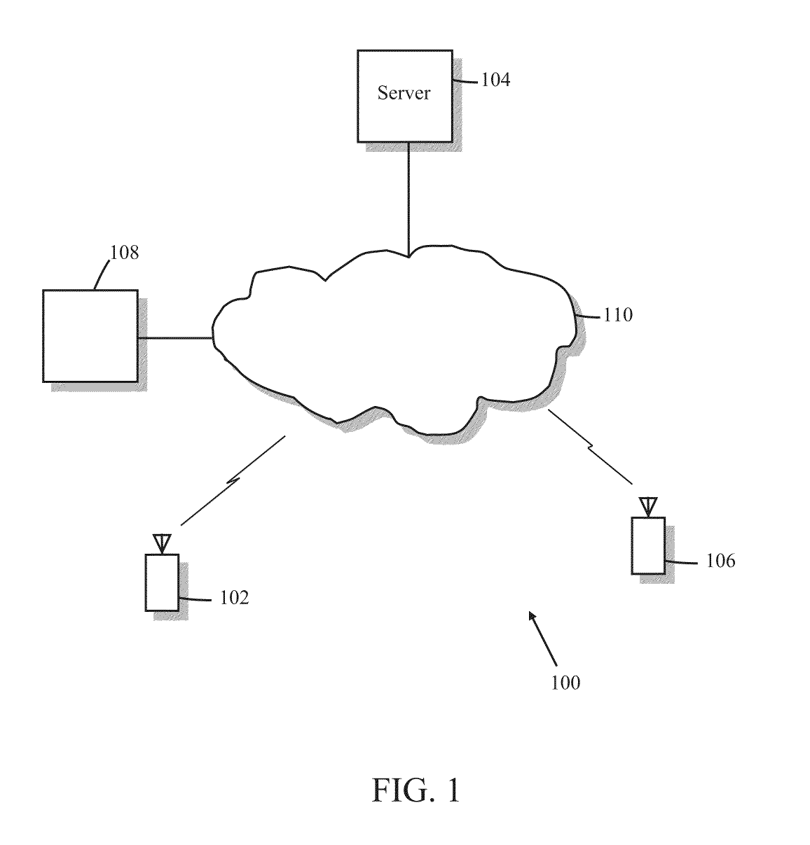

FIG. 1 is an illustration of one embodiment of a system 100 for managing work flow relating to a service provider network. Shown are customer wireless communication device 102, server 104, fixed customer computing device 106, service provider wireless communication device 108, and wide area network 110. The service provider network comprises a number of pre-registered service providers and customers, wherein the customers may easily order services from the pre-registered service providers via a customer work flow application running on customer wireless communication devices 102. The customer work flow application is used by customers to select service providers, order services, track progress of the services being performed, view and pay invoices related to the services, and provide feedback to other customers. Service providers use a work flow application to receive service requests from customers, respond to such requests, provide location information to the customer during job performance, track hours worked and materials used on a project, create invoices, receive payments, and leave feedback for other service providers.

A service provider network may be offered by a business entity for providing reduced costs to customers who use service offered by the pool of service providers registered by the business entity. This entity is typically responsible for developing processor-executable instructions for server 104 that allow server 104 to register service providers and customers, exchange service requests and acceptances between customers and service providers, manage invoicing and financial payments, etc. The business entity is also typically responsible for developing and distributing the downloadable work flow applications for customers and service providers. A single business entity may offer a wide variety of services, or it may offer only one kind of service, such as plumbing or electrical services. In any case, the business entity is structured to register a large number of service providers and customers in order to provide an easy way for customers to order services form the registered service providers as necessary. It should be understood that while FIG. 1 shows only one customer wireless communication device, one service provider communication device, and one wireless service provider communication device, in actual use, a plurality of such devices are typically used, each one by a different individual, organization, or service provider. It should be further understood that system 100 could additionally comprise non-wireless customer communication devices (not shown), such as desktop computers, for use by customers to manage work flows.

When a customer wishes to hire an individual or organization to perform a service for the customer, the individual may launch a software application, or “app”, that has been installed onto customer wireless communication device 102. This “work flow” app enables the customer to create a customer account, which may include the customer's address, phone number, email address, credit card information, or other information pertaining to a customer. The account can generally be modified at any time after account creation. Once an account is created, the work flow app allows customers to order services from a potentially large group of service providers that are pre-registered with server 104. In one embodiment, both customers and service providers register with server 104, which may provide centralized functions for managing work flows. For example, the server may be in communication with service providers to determine a present location of each service provider so that this information may be relayed to potential customers, as will be explained in greater detail herein. The server may perform other functions, such as providing billing information from service providers to customers, and allow payment of services by customers to service providers.

Service providers may be pre-screened by an operator or owner of server 104 to ensure that they meet a minimum quality standard set by the operator or owner before allowing service providers to register with server 104. Registration with server 104 entitles service providers to be a part of a potentially large network of other service providers who likewise register with server 104 and are accessible by customers registered with server 104. Registration typically will include the name of the organization or individual service provider, a physical address associated with the service provider, contact information such as an email address, phone number, IP address, etc., a description of services offered, a contractor license number, areas of expertise, a photograph of an individual service provider or one or more service employees of a service provider organization, hours of operation (e.g., the hours during which the service provider is willing to respond to service requests or not willing to respond to service requests), a preferred method of communication (e.g., text, telephone, email, etc.) and/or other information.

Similarly, customers who wish to utilize system 100 will typically download an app to customer wireless communication device 102 from either server 104 or, more likely, from an “app store” available to the general public such as the Apple app store maintained by Apple Computer of Cupertino, Calif. or the Android app store, maintained by Google Incorporated of Mountain View, Calif. Once installed, a user of customer wireless communication device 102 may launch the work flow app and immediately be able to view one or more service providers who are either registered with server 104 or are registered with server 104 and currently available to provide services. In one embodiment, only a limited amount of information is shown to the customer in regard to the service providers, unless the customer has previously registered with server 104 and is currently signed into the system via the work flow app. The customer typically will need to create an account with server 104 by setting up a security credentials for future logins, such as a username and password. The customer may then enter personal information, such as the customer's address, email address, telephone number, IP address, etc.

Once an account is created, and a customer has logged into his or her account via the work flow app on customer wireless communication device 102, the customer may send a service request to one or more of the service providers that have pre-registered with server 104. The service request may include information such as the type of service requested (e.g., plumbing, electrical, drywall, auto repair, personal services, etc.), a maximum price and/or rate that the customer is willing to pay for the service, a cost “window” that the customer is willing to pay for the service, a time frame in which the services must be completed, or other information. The service request(s) is/are received by the one or more selected service providers via a fixed or mobile communication device. In response, one or more of the service providers may respond to the service request by accepting or declining the request. In another embodiment, a service provider may reply to the service request with a request for further information, a proposed price for the services to be rendered, or other query.

In one embodiment, the service request message is sent to only one service provider. If the service provider accepts the request, an acceptance message is sent to the customer. If the request is declined, the request is sent to a second service provider for acceptance. This may occur at server 104 or the process may occur at customer wireless communication device 102. This process is repeated until a service provider accepts the service request.

The work flow app may provide an indication to the customer of which service provider accepted the service request and, in one embodiment, provides the customer with a real-time map of the location of the service provider after the service provider has accepted the service request. In another embodiment, the work flow app provides the real-time map of the service provider's location only after the service provider has indicated that the service provider is en route to the customer's address to begin the service.

Upon arrival at the customer's address, the work flow app may provide an indication to the customer that the service provider has arrived at the customer's address.

As the service is performed, the service provider may make notes, add material costs to an invoice that is created using a service provider app running on service provider wireless communication device 108, and otherwise tracks the service provider's progress as the service is performed.

When the service has been completed, the service provider may enter a “stop” time into service provider wireless communication device 108, which is received by the service provider app in order to determine a total number of hours that the service provider worked to provide the service. The app may generate an invoice for the service provider and the customer, based on the time that the service provider worked performing the service, plus any other costs due to, for example, materials need to complete the service. The invoice may then be provided to the customer via text, email, or other method.

The invoice may be received by the customer work flow app and presented to the customer. The customer may choose to pay the invoice using the work flow app. In this case, a payment screen may be presented to the customer, asking for payment information such as a credit card, or for the user to select a credit or debit card previously provided to the work flow app during the account creation or modification process. The payment information is then sent to the service provider or to a financial institution associated with the service provider.

In one embodiment, the customer may choose to leave feedback concerning an attribute of the service provider, such as the quality of the service, the price of the service, the customer's overall satisfaction level with the service, and/or other attributes. The feedback is sent to server 104, where it may be added to the service provider's account. The feedback is then generally available for other customers to view when deciding whether to send a service request to the service provider.

Further details and embodiments are described later herein.

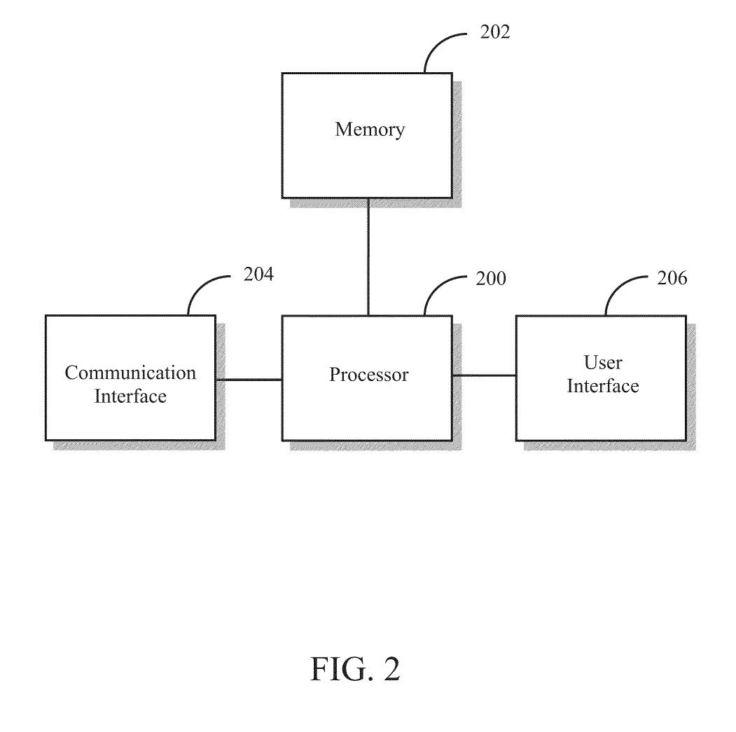

FIG. 2 is a functional block diagram of one embodiment of either customer wireless communication device 102 or service provider wireless communication device 108 (in this section, referred to as “communication device”). One or both of these devices may comprise a smartphone, tablet computer, laptop computer, notebook computer, or virtually any type of communication device capable of wireless communication with server 104. Specifically, FIG. 2 shows processor 200, memory 202, communication interface 204, and user interface 206. It should be understood that the functional blocks may be connected to one another in a variety of ways and that not all functional blocks necessary for operation of personal communication device are shown (such as a power supply), for purposes of clarity.

Processor 200 provides general operation of the communication device by executing processor-executable instructions stored in one or more computer-readable media, such as memory 202. Processor 200 additionally executes processor-executable instructions related to either the customer work flow app or the service provider app. Processor 200 typically comprises a general purpose processor, such as Tegra 2 processor manufactured by Nvidia Corporation of Santa Clara, Calif., although any one of a variety of microprocessors, microcomputers, and/or microcontrollers may be used alternatively.

Memory 202 comprises one or more information storage devices, such RAM memories, ROM memories, flash memories, and/or virtually any other type of electronic, optical, or mechanical memory device. Typically, memory 202 comprises more than one type of memory. For example, memory 202 may comprise a ROM memory used to store processor-executable instructions for operation of the communication device, plus RAM memory to store executable code related to either of the apps.

Communication interface 204 is electronically coupled to processor 200 and comprises electronic circuitry necessary for the communication device to communicate with server 104 via wired and/or wireless communication channels. Typically, communication interface 204 comprises hardware, software and/or firmware necessary to transmit and receive information sent via one or more commonly-used network protocols, such as the well-known TCP/IP suite of protocols. Alternatively, or in addition, communication interface could comprise a wireless transceiver configured to communicate over one or more well-known wireless communication standards, such as CDMA, TDMA, GSM, LTE, HSPA+, Ethernet, Wi-Fi, Bluetooth, fiber-optic communications, and so on.

User interface 206 is coupled to processor 200 and is used to allow customers or service providers to interact with the app, for example, entering account information, viewing service provider location, viewing information regarding a service request, receiving notifications of when a service provider has arrived at the customer site, when the service provider has begun or completed the service, etc. User interface 206 may comprise one or more touchscreens, pushbuttons, switches, sensors, keypads, and/or microphones that generate electronic signals for use by processor 200 upon initiation by a user. User interface 206 may, alternatively or in addition, comprise one or more display devices, such as one or more liquid crystal displays (LCDs), one or more light emitting diode displays (LEDDs), one or more light emitting diodes (LEDs), light arrays, or any other type of visual display. Further, user interface 206 could, alternatively or in addition, comprise an audio device, such as a speaker, for audible presentation of information to customers. Of course, the aforementioned items could be used alone or in combination with each other and other devices may be alternatively, or additionally, used. Typically, user interface 206 comprises a widely-known touchscreen device capable of displaying information and receiving user input.

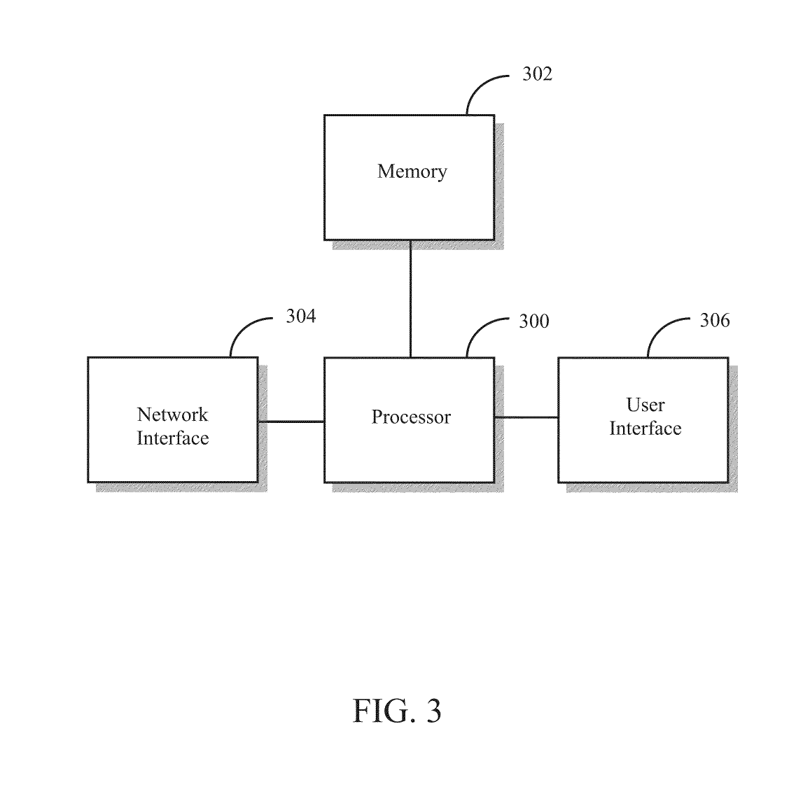

FIG. 3 illustrates a functional block diagram of one embodiment of server 104 shown in FIG. 1. Server 104 comprises a processor 300, a memory 302, a network interface 304, and, optionally, a user interface 306. The server may comprise a computer, application server, web server, or other electronic device that provides a variety of functions to support work flow between customers and service providers.

Processor 300 comprises a general-purpose microprocessor well known in the art or it may comprise a custom or semi-custom ASIC able to carry out the functionality required to support work flow management. Processor 300 generally executes processor-executable instructions stored in one or more mediums, such as memory 302, that control most or all of the functionality of the server. Examples of memory 302 include one or more electronic memories such as RAM, ROM, hard drives, flash memory, EEPROMs, EPROMs, Solid State Drive (s), etc. Network interface 304 comprises hardware and/or software configured to receive and process electronic communications from customers and service providers connected to one or more communication networks, such as the Internet, a fiber optic networks, radio networks, wired or wireless telephone networks, satellite networks, wired or wireless data networks, and/or any other well-known, two-way communication networks. In one embodiment, network interface 304 is configured to receive packet data using one or more well-known packet-based communication protocols, such as TCP/IP, UDP, etc.

Processor-executable instructions are stored in memory 302 that, when executed by processor 300, support work flow between customers and service providers. In one embodiment, the processor-executable instructions cause the server to allow service providers and customers to create and manage accounts. The instructions may further enable the server to provide service provider information to customers, receive service requests from customers, manage negotiations between customers and service providers, provide location information to customers and service providers, store information relating to services provided by service providers such as time spent performing services, part purchases, invoicing, and payment.

User interface 306 generally comprises hardware and/or software necessary for allowing a user of the server, such as an authorized technician or operator, to perform various duties related to the maintenance and upkeep of the server. Such duties may include entering information pertinent to the management of service providers. For example, such information may comprise adding a new service provider to a pool of approved service providers after the new service provider has been evaluated by a service providing agency, server administrator, or other entity, as having a minimum level of quality, credentials, etc. The information may further comprise recognition of certain certificates, licenses, or other governmental or regulatory credentials, updated contact information, or deletions of service providers from memory 302, among a wide variety of other duties. User interface 306 may comprise a keyboard, keypad, push-buttons, switches, a video display, a touch-screen device, a card reader, a microphone, an image capture device such as a still camera or video camera, a speaker, an RS-232 port, a USB port, a card reader, a network port, and/or virtually any other device that allows a user to communicate with the server.

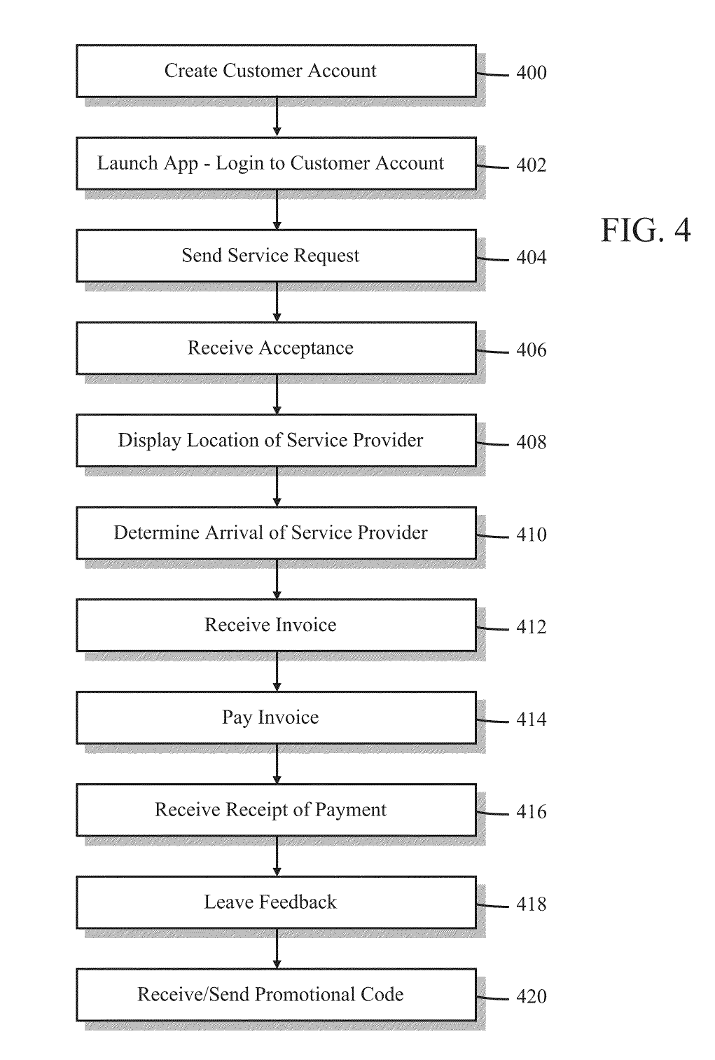

FIG. 4 is a flow diagram illustrating one embodiment of a method for managing work flow between a customer and a service provider as performed by a customer application running on the customer mobile communication device shown in FIG. 1. The method is implemented by a processor, such as processor 200 shown in FIG. 2, located within a customer wireless communication device 102, executing processor-readable instructions stored in memory 202 as shown in FIG. 2. It should be understood that in some embodiments, not all of the steps shown in FIG. 4 are performed and that the order in which the steps are carried out may be different in other embodiments. It should be further understood that some minor method steps have been omitted for purposes of clarity.

At block 400, a customer creates an account with server 104 by launching an app on his or her wireless communication device 102, calling a representative on a telephone, visiting a web page of an organization that offers a pool of service providers, or some other way. During the registration process, the customer is typically assigned a username and password for authenticating the customer during future service requests. The account may include a home and/or business address associated with the customer, contact information, credit/debit card information, preferred service provider information, preferred method of contact, and/or other information.

At some time later, at block 402, the customer launches the work flow app again in order to place a service request. The customer may need to “sign in” by providing his or her assigned username and password to the work flow app, wherein the work flow app then sends this information to server 104 for authentication.

The service request corresponds to a service that is desired by the customer. The type of services that may be requested by a customer is almost limitless and includes such services as appliance repair, automobile repair, home repair, home improvement, massage services, financial services, consulting services, etc. The customer uses the work flow app to enter the service request. The service request may comprise information pertaining to the type of service that is desired by the customer along with customer preference information, such as a location where the services are to be performed, a maximum dollar amount that the customer will pay for the service, hours that the customer prefers the service to be performed, a minimum satisfaction rating compiled from other customer reviews, minimum certifications needed to perform the service, whether a license or certification is required/desired by the customer, a maximum distance between the customer and a potential service provider, etc. Some of these items listed above may be referred to as “service provider preference information” e.g., a characteristic associated with a service provider, such as a minimum satisfaction rating, minimum certifications, whether such certifications are required by the customer to complete a service, a distance that a service provider is away from a customer job site, etc. A service request message may be constructed by processor 202 by presenting a number of drop-down menus to the customer via user interface 206, each drop-down menu relating to a characteristic of a service request. For example, a first drop-down menu might comprise a service request type, for example, plumbing, electrical, drywall, pool/spa, automobile, personal services, etc. Another drop-down menu might allow the customer to select a maximum price that the customer is willing to pay for the service. In other embodiments, drop-down menus could be replaced with any information entry method known in the art.

In one embodiment, a visual indication of pre-authorized service providers is displayed to the customer that are within a certain distance from the customer's current location, or within a certain distance from the customer's home or business location, as provided by the customer during the account creation process. It should be understood that reference will be made to such pre-authorized service providers herein as simply “service providers”, unless otherwise designated. Each of the service providers displayed to the customer has previously been approved by a central authority entity, such as a business entity or organization that offers a pool of service providers to customers. In one embodiment, an icon is displayed on a map, representing some or all service providers that are registered with server 104, or some sub-set thereof. For example, only service providers that are presently “on duty” might be displayed. In another embodiment, a visual indication of potential service providers is displayed to the customer after the service request is entered into the work flow app, so that only service providers meeting the customer's requirements, such as time, price, distance, rating, etc., may be displayed to the customer. The customer may then select one or more service providers from the visual display so that the service request is only sent to those selected service providers.

The app may allow the customer to review detailed information about any of the service providers displayed to the customer, simply by touching an icon representing one of the service providers. In response, the work flow app displays detailed information about the service provider, such as contact information, ratings, hourly cost, certifications, licenses, photographs, availability (e.g., current status, “on duty”, “on-duty, unavailable”, or “off duty”), etc., to the customer. This feature may allow the customer to better decide who to use to perform the desired service.

At block 404, processor 202 sends the service request message to communication interface 204, where it is sent to server 104. Server 104, in turn, receives the service request message and determines which service providers are appropriate for the service requested by the customer, in accordance with any customer-applied limitations, such as distance, time, cost, preferred service provider, etc. In one embodiment, server 104 sends an invitation to only one service provider selected by server 104 based on the customer's service request and/or predetermined criteria available to server 104. If that service provider rejects the invitation, or fails to respond to the invitation within a predetermined time period, for example 15 minutes, the invitation is rescinded to the first service provider and the invitation is then sent a second service provider qualifies to render the service. This process continues until a service provider accepts the invitation. Server 104 then sends a notification to the customer that a service provider has accepted the customer's service request.

In another embodiment, server 104 sends the service invitation to a number of service providers at or near the same time, receives responses from one or more of them, and then may aid in a negotiation between the requesting customer and the one or more service providers to arrange for a service to be performed by one of the service providers. In one embodiment, server 104 determines which of the responding service providers to award the service request, based on a set of predetermined criteria stored within memory 302, such as a quality rating of each service provider, the distance that each service provider is from the customer location (closest service provider receiving the award), a preference by the customer, etc. In another embodiment, each, or a subset of each, response is forwarded by server 104 to the customer so that the customer may negotiate with the responding service providers and, ultimately, select one of the service providers to perform the requested service.

In yet another embodiment, the service request message sent from the communication interface 204 is sent directly to one or more service providers, bypassing server 104. This embodiment may be used in a slightly less sophisticated system 100, where the work flow app running on customer wireless communication device 102 and server 104 are less involved in the overall work flow process. In one embodiment, the service request message is sent to each of the service providers selected by the customer in the visual display of the customer's wireless communication device, as described above.

At block 406, a notification of acceptance of the service request is received by communication interface 204. The notification of acceptance is sent by server 104 in response to an acceptance of an invitation sent by server 104, or it may be sent directly to the customer by one of the service providers. The notification of acceptance may be received via SMS message (text), email, by an automated telephone call, via a message displayed via the work flow app, or a combination of these.

At block 408, processor 202 may display the current location of the selected service provider via user interface 206 and may cease displaying the location of all other service providers, so that the selected service provider is more prominently displayed to the customer. Additionally, or alternatively, an estimated time of arrival is presented to the customer via user interface 206. The estimated time of arrival may be calculated by the work flow app based on location information of the selected service provider, by server 104, by a work flow app being executed on the selected service provider's wireless communication device 108, or a combination of these. The location of the selected service provider may be received continuously, at periodic time intervals, or upon the occurrence of one or more predetermined events, such as when the selected service provider is within a first, second, and/or third predetermined distance from the customer or location where the customer desires performance of the service. The location of the selected service provider is generally determined by server 104, and then provided to the customer via the customer's wireless communication device 102.

At block 410, processor 202 may determine that the selected service provider has arrived on the job site by comparing a current location of the selected service provider to the job site location. Processor 202 may generate an alert of such arrival to the customer via user interface 206. The selected service provider and the customer will typically meet, and the selected service provider may begin to perform the service. If parts are required to perform the service, the selected service provider may leave the job site to purchase the required parts and the location of the selected service provider may be displayed by the work flow app to user interface 206.

After the selected service provider has completed performing the service for the customer, at block 412, an invoice from the service provider may be received by the work flow app over customer wireless communication device 102. The invoice is typically sent from the selected service provider to server 104 where it may be stored, then forwarded to the customer.

At block 414, the customer may choose to pay the invoice via the work flow app by accessing credit card information stored in the customer's account at server 104, stored locally on customer wireless communication device 102, or by manually entering credit card information into the work flow app. In one embodiment, the customer may have received a promotional code to receive a discount for using the work flow app to arrange for services. The customer may enter the promotional code and receive a discount.

The credit card information is then transmitted to server 104, and server 104 credits an account associated with the selected service provider and debits a credit card account associated with the number provided by the customer. Sever 104 may transmit a notification to the selected service provider indicating payment of the invoice. If a promotional code was used to provide a discount to the customer, the discounted amount is provided to the selected service provider by management of the organization operating, maintaining, or owning server 104.

At block 416, the customer may receive a receipt indicating that the invoice has been paid. The invoice is typically sent by server 104 in response to successful payment of the invoice at block 414.

At block 418, the customer may choose to leave feedback regarding the performance of services, value, cost, and/or other metric associated with the selected service provider and the services that were performed. The customer may use the work flow app to enter this information. In one embodiment, the ratings are then sent by customer wireless communication device 102 to server 104, where it is stored in association with the selected service provider. Thereafter, server 104 may compile various ratings related to the selected service provider and provide the compiled ratings, as well as individual ratings, to potential customers who use the work flow app. In another embodiment, the ratings may be sent to individuals via email or SMS, to the customer's Facebook page, Twitter, or other social networking web sites.

At block 420, the customer may choose to send a promotional code for a reduction in service performance costs to a friend or other individual. The customer may have received a promotional code from another customer or from an advertisement. The customer enters or selects a friend or other individual into the work flow app and an identification of the promotional code, and the work flow app then sends the promotional code to the friend or other individual via communication interface 204.

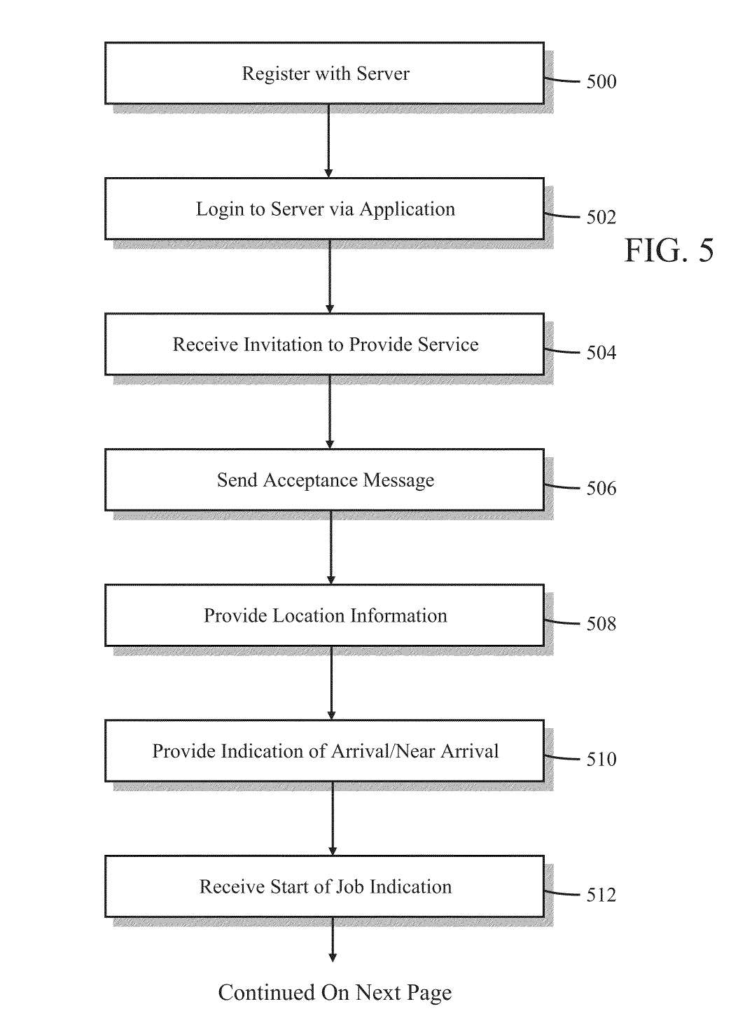

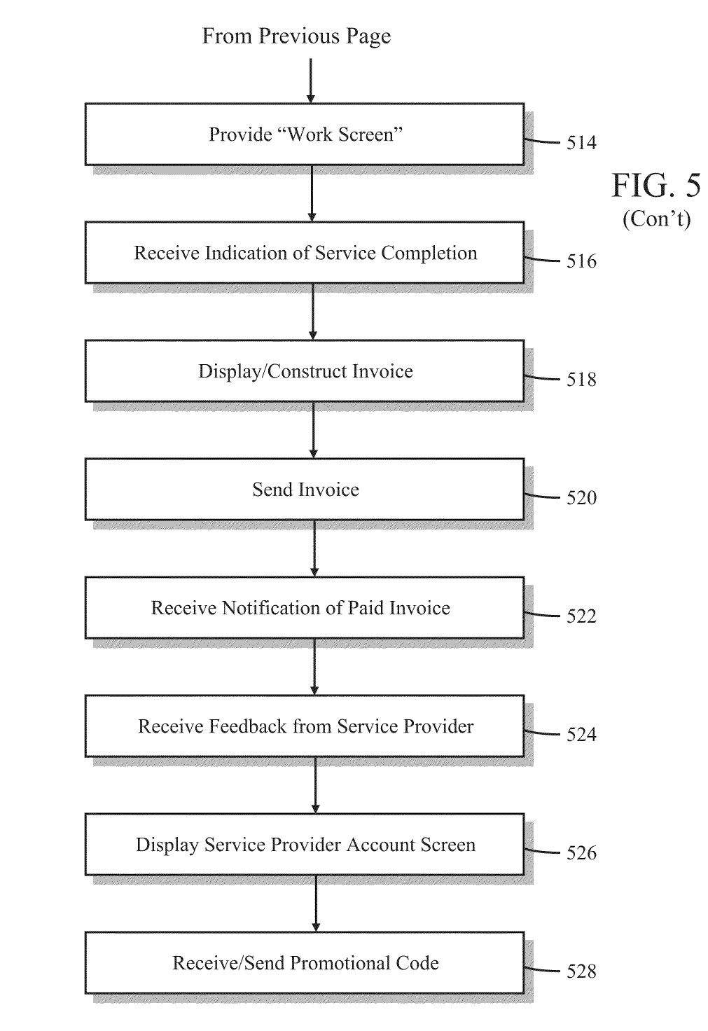

FIG. 5 is a flow diagram illustrating one embodiment of a method for managing work flow between a customer and a service provider as performed by a service provider application running on the service provider mobile communication device shown in FIG. 1. The method is implemented by a processor, such as processor 200 shown in FIG. 2, located within a service provider wireless communication device 106, executing processor-readable instructions stored in memory 202 as shown in FIG. 2. It should be understood that in some embodiments, not all of the steps shown in FIG. 5 are performed and that the order in which the steps are carried out may be different in other embodiments. It should be further understood that some minor method steps have been omitted for purposes of clarity.

At block 500, a service provider registers with server 104 by launching a service provider work flow app on his or her wireless communication device 106, calling a representative on a telephone, visiting a web page of an organization that offers a pool of service providers, or some other way. During the registration process, an account is created and stored by server 104, and the service provider is typically assigned a username and password for authenticating the service provider during future interactions with server 104. This may be all that is required to establish an account with server 104. However, the service provider may provide other information at this time, such as a name of the service provider or service provider organization, home and/or business address associated with the service provider, contact information (e.g., email address, phone number, web site address, etc.) preferred method of contact, certificates or license numbers held by the service provider, photographs of such certificates or licenses, photographs of the provider, photographs of representative work performed by the service provider, financial information such as a bank account number for receiving payment from customers, rate information, status information (e.g., currently “on duty” or “off duty”) and/or other information pertinent to performing services for customers. This information may be provided at the time of initial registration, or at a later time.

In another embodiment, the account creation process may be performed by a representative of an organization having multiple service providers. In this case, the representative may enter information regarding the organization itself and, additionally, information pertaining to one or more of their employees or contractors who actually perform services.

In one embodiment, the service provider is not able to offer services via server 104 until one or more of his or her credentials have been verified by management of server 104. If the credentials are successfully verified, the service provider may be provided with notification from server 104 that the service provider has been verified and is able to offer services via server 104. Verification may include evaluation of photographs uploaded by the service provider during initial registration with server 104 of certificates and/or licenses held by the service provider.

At some time after the registration process, at block 502, the service provider launches the service provider work flow app again when the service provider is willing to provide services for customers. The service provider may need to “sign in” to his account held by server 104 by providing his or her assigned username and password to the work flow app, wherein the work flow app then sends this information to server 104 for authentication.

After logging into his or her account, the service provider app may display a visual “main screen” to the service provider, showing a display of the service provider and other service providers in geographic proximity to the service provider, as well as other information, such as a current service provider status (e.g., “on duty” or “off duty”). The status may be provided to the service provider upon successful login to the service provider's account. If the service provider wishes to change his or her status, the service provider may enter a new status and send the new status to server 104. Server 104 uses the status information to update the current status of the particular service provider so that potential customers know whether the particular service provider is currently available to perform services or not.

The main screen can also display other information, such as a name and photograph of the service provider as uploaded by the service provider during the registration or updating process, the service provider's rate to perform services, their stated expertise, license, and/or certificates, a total number of jobs performed in a given time period, such as per day, week, month, or year, and the total dollars earned in a given time period.

At block 504, the service provider may receive an invitation from server 104, indicating that a service request has been received by server 104. In another embodiment, the invitation originates directly from a potential customer. Upon receipt of the invitation, the service provider app alerts the service provider of the invitation. The invitation may comprise information such as an address where the potential customer would like the work performed, a present location of the potential customer, contact information of the customer, a description of the services needed, a maximum amount that the potential customer is willing to pay, a time frame in which the services must be completed, hours during which the potential customer is willing to have the service performed, etc. This information may be displayed to the service provider after, or along with, notification of the invitation. In another embodiment, when a service provider receives an invitation from server 104, he or she (or it) has already met the requirements of the service request from the customer and, therefore, at least some of the additional information contained in the service request might not be provided to service providers at this time.

In one embodiment, the service provider has only a limited time period in which to respond to the invitation. In one embodiment, the time period is one minute. The time period for response may be displayed to the service provider, in one embodiment, by displaying a count-down timer. Shorter time periods are seen as an incentive to service providers to accept or reject jobs quickly. This incentive acts as a benefit to customers by allowing their service requests to be filled quickly.

In one embodiment, if the service provider fails to respond to the invitation in the given time period, or if the service provider rejects the invitation by providing an indication to user interface 206, the invitation is revoked or rescinded by server 104, and sent to another service provider, thereby excluding the service provider from performing the requested service. The service provider may receive notification from server 104 that the invitation has been rescinded. In an embodiment that makes use of a count-down timer, the count-down timer will typically indicate “zero” time left to respond to the invitation, and processor 200 will prevent the service provider from entering an acceptance of the invitation. In another embodiment, process 200 allows an acceptance from the service provider, but generates a message to the service provider via the user interface, that the invitation is no longer valid, or that the service provider responded too late to the invitation, or some other similar indication.

At block 506, if the service provider accepts the invitation, a message is generated by the service provider app and sent to server 104 indicative of the acceptance. Alternatively, or in addition, an SMS message, email, “tweet” or other indication is generated and sent directly to the customer who requested services. Upon receipt of the acceptance message, server 104 provides an indication to the requesting customer that the customer's service request was accepted, and information about the service provider, along with, in one embodiment, the service provider's current location, an estimated time of arrival at the customer's job site, and/or other information. In one embodiment, either during acceptance of the invitation, or after, the service provider may specify a time that the service provider expects to arrive at the customer's job site. As a result of accepting the invitation, in one embodiment, a map is displayed to the service provider, showing the service provider's current location, a location where the services are to be performed, and/or directions to the location where the services are to be performed.

In another embodiment, if the service provider accepts the invitation, a message is generated by the service provider app and sent to server 104 as before. However, in this embodiment, other acceptances of the service request may have been received by server 104. In this case, server 104 may negotiate with the requesting customer to determine which of the service providers that accepted the invitation the customer would like to use. This negotiation process may include or exclude the service providers who accepted the invitation. For example, a bidding process may be implemented by server 104, where server 104 receives bids from the service providers who accepted the invitation, and the service provider having the lowest bid wins the job. Server 104 then may provide an indication to the requesting customer of which service provider won the bid and the amount that the job will cost.

In another embodiment, server 104 acts as an intermediary between the service providers who accepted the invitation and the requesting customer, so that the requesting customer has more of a hand in deciding which service provider to hire. Upon final acceptance, information regarding the selected service provider is provide to the customer via server 104, such as a current location of the selected service provider, an estimated time of arrival, etc.

In one embodiment, when an invitation to a service request has been accepted by the service provider and/or the customer, the service provider's status is changed from “available” to “busy” (or “on duty, available” to “on duty, unavailable or the like) automatically by server 104. This information is provided to other customers who may be seeking services using the customer work flow app.

At block 508, as the service provider is on the way to the customer's job site, an indication of the service provider's current location and/or an estimated time of arrival is transmitted to server 104 for relay to the customer. Additionally, or alternatively, this information may be sent directly to the customer via SMS, email, Twitter, etc.

At block 510, when the service provider is within a predetermined distance from the job site, e.g., 500 feet, the service provider app may allow the service provider to provide an indication to the customer that the service provider is just about to arrive at the job site or that the service provider has arrived at the job site. In one embodiment, this is accomplished by providing an icon on the user interface that is inactive or “greyed-out” until the service provider is within the predetermined distance. Then, when the service provider is within the predetermined distance, the icon becomes activated, allowing the service provider to indicate that he or she is a about to arrive on the job site or that the service provider has arrived. In another embodiment, the service provider app automatically generates this message and transmits it to the customer when the app determines that the service provider is within the predetermined distance from the job site.

At block 512, the service provider app may provide an icon to the service provider that allows the app to begin tracking the elapsed time that the service provider has been working at the customer job site. The service provider may begin tracking the elapsed time by pressing the icon. As a result of pressing the icon, processor 300 receives an indication to begin tracking the elapsed time. The elapsed time may be paused at any time by the service provider, for example, if the service provider takes a lunch break during the time services are being performed for the customer.

At block 514, a “work screen” may be displayed to the service provider by the service provider app, indicating the elapsed time that the service provider has been working at the job site, the rate of pay that is being charged to the customer, an elapsed amount that the service provider has earned based on the elapsed time and the rate of pay, and/or an area where the service provider may enter any comments about the job, such as an initial condition of the job site, comments made by the customer, etc. The app may allow the service provider to take and store photographs of the job site, or items in and around the job site, as services are performed, along with the comments.

In one embodiment, the work screen may allow the service provider to enter material procurement information, such as information relating to parts and/or materials purchased for the job. For example, during repairs to a customer's washing machine, a service provider may determine that a new valve is needed. The service provider may then travel to an appliance parts store and purchase a new value for the customer. The service provider may then enter a description of the item(s) purchased, quantities purchased, and a cost associated with the item(s). The app may determine the total cost of the item(s) purchased using, in one embodiment, sales tax information provided by the service provider or server 104. In one embodiment, the app allows the service provider to take a photograph of the receipt and store it in association with the description and price information previously entered by the service provider. The work screen may be updated with the purchase information, providing a convenient way for the service provider to know, in real time, the total cost of the parts and services need to complete the job for the customer.

At block 516, the service provider may provide an indication to the service provider app that the services have been completed, typically by pressing an icon indicative of such. As a result, an indication is received by processor 300 via user interface 306 that the service has been completed. The app may then calculate the total time that the service provider spent performing services for the customer by subtracting the end time from the start time, less any time spent on breaks or for some other non-work related work stoppages.

At block 518, the service provider app may provide an “invoice screen” where an indication of the total cost of providing the service to the customer may be displayed. The indication may be displayed as an invoice, detailing the rate of pay, number of hours/minutes that the service provider worked, a description and cost of items purchased to complete the service, taxes, travel costs incurred by the service provider, etc.

At block 520, the service provider may send an invoice to the customer electronically via the service provider app and server 104, by pressing an icon on user interface 206. Additionally, or alternatively, the invoice may be sent by the app directly to the customer via SMS, email, or some other electronic means. In yet still another embodiment, additionally, or alternatively, the app may print the invoice using a printer provided by the customer or the service provider.

At block 522, at some later time, the service provider app may receive an indication from server 104 that the customer has paid the invoice. The money paid by the customer may have been deposited into an account held by the service provider, and indication of which was provided to server 104 during the registration process or sometime thereafter.

At block 524, the service provider app may allow the service provider to provide feedback of the service provider's experience with the customer. In one embodiment, the service provider may provide simply an overall experience of either “good” or “bad”. In other embodiments, the service provider may be able to enter text or photographic feedback, and/or rate the customer in various categories, such as “prompt payer”, “easy to work with”, etc.

At block 526, the service provider app may allow the service provider to view a screen displaying information pertaining to the service provider's financial records of services performed. For example, the screen may display a number of jobs completed by the service provider, the total earnings from those jobs, and/or the ability to select any one of the jobs and be shown detailed information concerning the job (such as an invoice associated with the selected job). In one embodiment, the service provider may be able to transfer funds from one account to another, add or modify banking or account information, etc.

At block 528, a promotional code may be provided to the service provider by server 104. The promotional code may be sent by the service provider to friends, family, existing clients, etc. of the service provider as an enticement to create an account with server 104 and to use the services offered by the business entity managing the service provider network. In another embodiment, the service provider may generate a promotional code and sent to family and friends. The promotional code typically comprises a discount for future services. The service provider may, in one embodiment, select one or more previous customers, friends, or family to send the promotional code from an address book stored in memory 202. The promotional codes generated by the service provider are stored by processor 200 in memory 202 along with a notation of where the promotional code was sent, i.e., an email address, telephone number, name, etc.

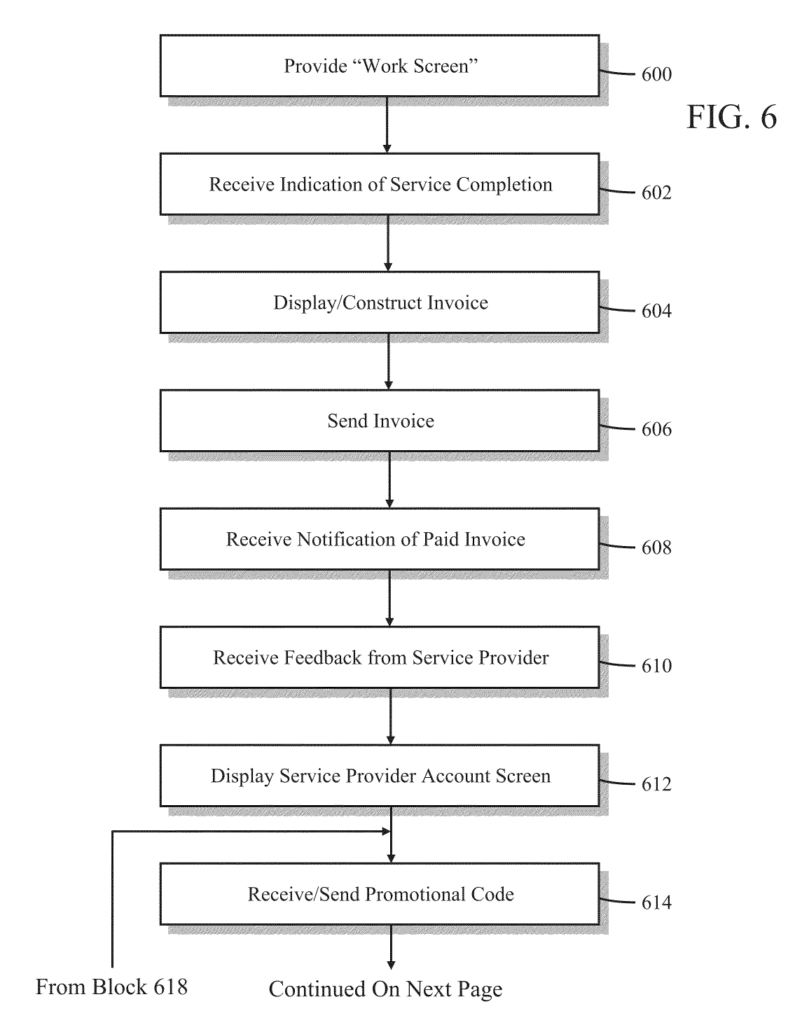

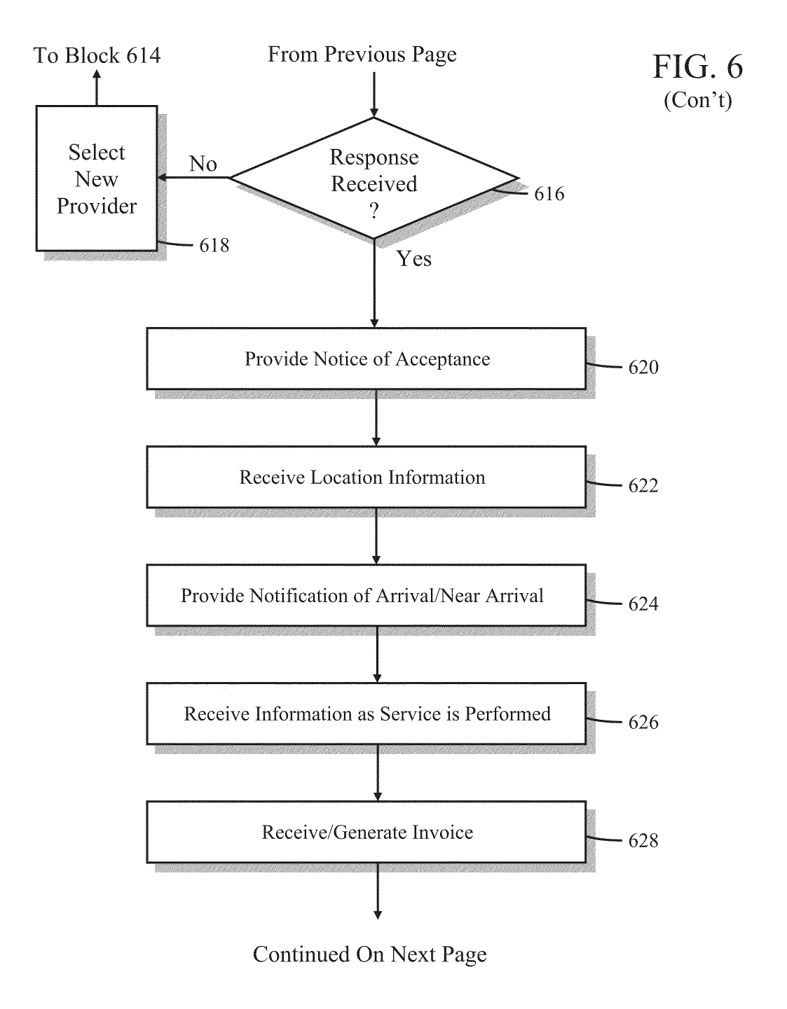

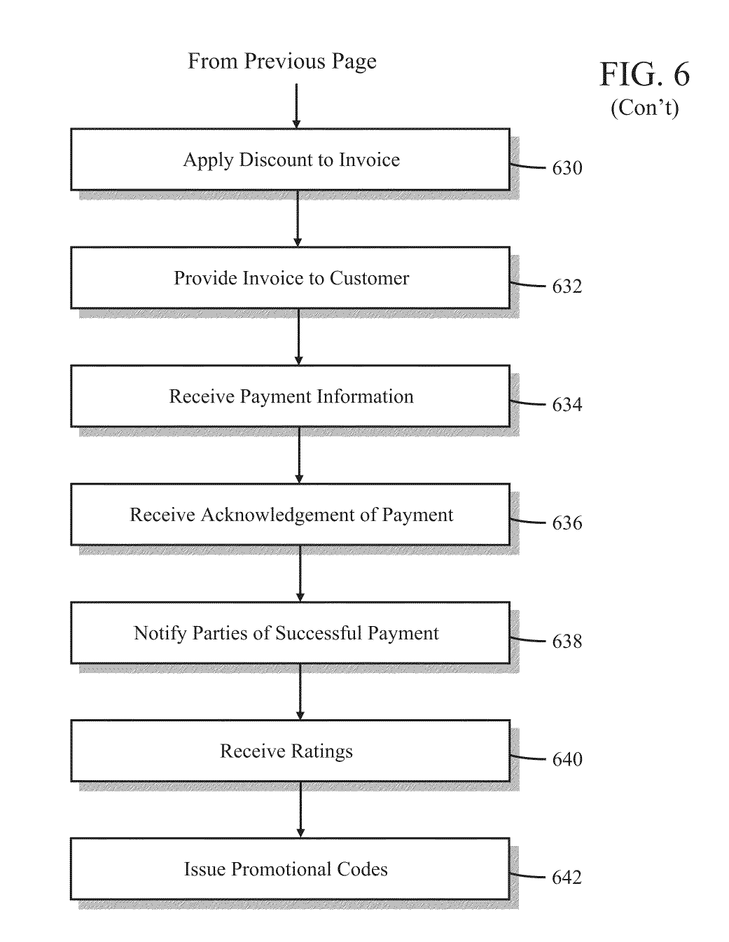

FIG. 6 is a flow diagram illustrating one embodiment of a method for managing work flow between a customer and a service provider. The method is implemented by a processor, such as processor 300 shown in FIG. 3, located within sever 104, executing processor-readable instructions stored in memory 302 as shown in FIG. 3. It should be understood that in some embodiments, not all of the steps shown in FIG. 6 are performed and that the order in which the steps are carried out may be different in other embodiments. It should be further understood that some minor method steps have been omitted for purposes of clarity.

At block 600, the server creates an account for a customer as a result of the customer contacting server 104 via network interface 304. The initial contact by the customer may be initiated by a customer work flow application executed on a customer wireless communication device 102, by a representative of a business entity offering services from a large number of registered service providers in communication with the customer via phone, email, or other electronic communication means, by the customer using a web site offered by the business entity, etc. The customer typically provides information such as an address, phone number, email address, and/or credit card information associated with the customer.

At block 602, the server creates an account for a service provider as a result of the service provider contacting server 104 via network interface 304. The initial contact by the service provider may be initiated by a service provider work flow application executed on a service provider wireless communication device 106, by a representative of the business entity in communication with the service provider via phone, email, or other electronic communication means, by the service provider using a web site offered by the business entity, etc. Typically, server 104 registers a large number of service providers so that customers will have a wide variety of service providers to choose from when a need arises for services to be performed. The service provider typically provides information such as name of the organization or individual service provider, a physical address associated with the service provider, contact information such as an email address, phone number, IP address, etc., a description of services offered, a contractor license number, areas of expertise, a photograph of an individual service provider or one or more service employees of a service provider organization, hours of operation (e.g., the hours during which the service provider is willing to respond to service requests or not willing to respond to service requests), a preferred method of communication (e.g., text, telephone, email, etc.) and/or other information. In the case of an organization having one or more employees and/or contractors, an account may be set up by server 104 on behalf of the organization, and information pertaining to the employees/contractors are added to the organization's account information.

At block 604, server 104 may receive information from one or more of the registered service providers indicating a current status of each of the service providers, e.g., “on duty, available”, “on-duty, busy”, or “off duty”). Server 104 may, in response, provide this information to an account associated with each respective service provider that provided a current status to server 104.

At block 606, server 104 may receive a login request from a customer who has pre-registered with server 104. Upon successful authentication, a notification of such is sent to the customer via network interface 304. Server 104 may receive information from the customer pertaining to a current location of the customer.

At block 608, server 104 may generate information regarding one or more authorized service providers and provide the information to the customer. For example, server 104 may provide information regarding any authorized service provider within a predetermined distance from the current location of the customer or, alternatively, a location stored in the customer's account (such as a home address). Alternatively, or in combination, server 104 may provide information regarding one or more authorized service providers having at least a minimum quality rating as provided by other customers. Such information may be found in each service provider's account that is stored in memory 302. In one embodiment, the information comprises each service provider's availability information, current status, pricing information, and/or other information provided by the service providers during the registration or updating process. The information is sent to the customer via network interface 304 for use by the customer work flow application running on customer wireless communication device 102. The customer work flow application may use this information to construct a display for the customer to view the available service providers nearby the customer, or having other characteristics desirable to the customer, and provided by the customer to the customer work flow application running on the customer's wireless communication device.

At block 610, server 104 receives a service request from the customer. The service request may comprise a type of service, a location where the services are to be performed, a maximum dollar amount that the customer will pay for the service, hours that the customer prefers the service to be performed, a minimum satisfaction rating desired by the customer that has been compiled from other customer reviews, minimum certifications needed to perform the service, whether a license or certification is required/desired by the customer, a maximum distance between the customer and a potential service provider, and/or other information. In another embodiment, the service request comprises a selection, by the customer, of one or more service providers the customer would like to provide the service request to, such as electricians within 10 miles of the current location of the customer having a quality rating greater than a minimum threshold. In response, server 104 provides an invitation to one or more of the selected service providers to provide a service to the customer, as described below.

At block 612, in one embodiment, server 104 may determine which service provider, matching the service request, is closest to the current location of the customer, or a job site indicated within the service request. In another embodiment, one or more service providers are selected by server 104 in accordance with the service request, each of the selected service providers selected to receive an invitation to respond to the service request. In either embodiment, the service provider's current status may be used to exclude any service provider that is presently unavailable, such as any service provider having a current status of “off duty” or “on duty, unavailable”. In yet another embodiment, neither of these steps is performed in an embodiment where the service request comprises an identification of one or more service providers the customer would like to provide the service request to.

At block 614, in one embodiment, server 104 sends an invitation to the service provider identified as being closest to the customer (and meeting the requirements of the service request). In another embodiment, the invitation is sent to the one or more service providers identified by server 104 as meeting the requirements of the service request, such as any automobile mechanics specializing in brake repair within 5 miles of the customer's home address, as stored in the customer's account in memory 302. In yet another embodiment, the invitation is sent to the service providers selected by the customer and provided in the service request.

At block 616, in one embodiment, server 104 determines whether a response has been received from the sole service provider that was sent the invitation within a predetermined time period, such as five minutes. If no response has been received, a second service provider is selected by server 104 meeting the requirements of the service request at block 618, and a second invitation is sent to the second service provider, shown back to block 614. This process repeats until an acceptance is received from one of the service providers.

In an alternative embodiment where multiple service providers were provided the invitation, server 104 may receive responses from several service providers within a predetermined time period. The responses may include a current status and/or location of the service provider. Of the responses, server 104 may award the job pertaining to the service request to one of the service providers, such as the first service provider to respond, the service provider having the highest rating, the service provider closest to the customer, and/or a combination of these and/or other factors. In another embodiment, information pertaining the responses from the responding service providers may be sent to the customer via network interface 304. In this way, the customer and the service providers may determine which service provider will be awarded the job related to the service request. Ultimately, an indication of a selection of one of the service providers is supplied to server 104 by the customer.

Referring back to block 616, in one embodiment, if a response is received from one of the service providers accepting the invitation, server 104 provides a notification to the customer of the service provider who has accepted the invitation to perform services for the customer at block 620. The current location of the service provider may also be provided to the customer for display to the customer by the customer work flow application.

At block 622, server 104 receives updates of the location of the selected service provider and provides the updated location information to the customer. In one embodiment, the updated location is provided to the customer only if the service provider has provided an indication to server 104 that the service provider is on his or her way to the customer's job site. Sever 104 may also provide an estimated time of arrival to the customer based on the current location of the service provider or based on an indication received from the service provider.

At block 624, server 104 may provide a notification to the customer when the service provider is within a predetermined distance from the customer's job site, as indicated by the location information provided by the service provider, indicating arrival, or imminent arrival, of the service provider at the customer job site. In another embodiment, the customer work flow application determines when the service provider is within a predetermined distance from the customer's job site, and alerts the customer that the service provider has, or is about to, arrive at the job site.

At block 626, as services are being performed by the service provider, server 104 may be provided information pertaining to the work being performed, such as a job start time and end time, times where breaks are taken by the service provider, digital images pertaining to the job, material purchase information, digital images of receipts, invoices, etc. This information may be stored in the service provider's account, the customer account, or both.

At block 628, after the service has been completed, server 104 may receive a completed invoice from the service provider or, in another embodiment, be provided with all of the details necessary for server 104 to generate an invoice, such as the time spent working on the job, cost of materials purchased for the job, etc. In either case, the invoice may be stored in association with the customer and/or the service provider.

At block 630, server 104 may apply a discount to the invoice in association with a promotional code received from the customer, the service provider, and/or both.

At block 632, server 104 may provide the invoice to the customer.

At block 634, the server 104 may receive payment of the invoice in the form of authorization to charge an account, credit card, or debit card belonging to the customer. In one embodiment, server 104 receives authorization from the customer to use account information already stored in the customer's account. Server 104 may then credit an account associated with the service provider in an amount equal to the invoice, and debit an account associated with the customer. In another embodiment, server 104 simply notifies a financial institution that the customer wishes to pay the service provider an amount equal to the invoice amount, and the financial institution provides a credit to the service provider.

At block 636, server 104 may receive an acknowledgement from the financial institution that the invoice was paid successfully.

At block 638, server 104 may notify the customer and/or the service provider that the invoice was successfully paid. Server 104 may additionally perform accounting for either the customer and/or the service provider by calculating and storing information pertaining to services requested by the customer and provided by the service provider. For example, server 104 can calculate the total number of times that services were requested by the customer, the total dollar amount of the services, an average dollar amount of the services, a listing of each service provider that has performed services for the customer, a ranking of each service provider as provided by the customer, warranty information provided by service providers, etc. As another example, server 104 can calculate the total number jobs completed each service provider, the number of times that services were requested by a particular customer, a number of times that services were rendered for a particular customer, the total dollar amount charged for the services performed, the total dollar amount collected for the services performed, a collection rate associated with all customers or for each customer, etc. a ranking of each customer as provided by the service provider, warranty information provided to customers, etc.

At block 640, server 104 may receive a rating from either the customer, the service provider, or both, related to the services that were performed. The customer may rate the performance of the service provider using a variety of criteria, as explained previously. Likewise, the service provider may choose to provide feedback regarding characteristics of the customer or the service that was performed. Server 104 may store these ratings in association with respective accounts of the customer and service provider in memory 302. In addition, or alternatively, the ratings may be sent to a web site or social media site managed by the network service provider, or sent to individuals specified by the customer and/or service provider via email, SMS, Facebook, Twitter, or other social networking web sites.

At block 642, server 104 may issue promotional codes to the consumer or to the service provider. The promotional codes offer a discount to customers, paid for by either the network service provider, one or more service providers, or both. Customers may use the promotional codes to reduce the amount owed to service providers, or they may provide them to friends and family for their use. Service providers may forward promotional codes to existing customers, friends, or family, to entice them to register with the service network. Upon use by such existing customers, friends, or family, server 104 may provide a monetary reward to the service provider that provided the promotional code to existing customers, friends, or family.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. In the alternative, the processor and the storage medium may reside as discrete components.

The subject matter described herein can be implemented as software that is stored in one or more storage devices and that executes on one or more processors. As another example, the subject matter can be implemented as instructions that are stored on one or more processor-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Accordingly, an embodiment of the invention may comprise a non-transitory processor-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A processor-readable media having processor-executable instructions stored thereon for execution by a processor to perform a method for managing work flow for a customer using a wireless communication device, comprising:
instructions for the processor to receive a service request from the customer via a user interface on the wireless communication device, the service request comprising a type of service desired by the customer;
instructions for transmitting the service request by a communication interface in the wireless communication device to a central server, the central server for providing an invitation, based on the service request, to service providers that are pre-authorized by a central authority entity and who offer services matching the type of service identified in the service request; and
instructions for a receiver in the wireless communication device to receive an acceptance of the service request from the central server, the acceptance provided by one of the pre-authorized service providers that received the invitation to the central server.

2. The processor-readable medium of claim 1, further comprising:
instructions for the user interface to visually display information relating to pre-authorized service providers within a predetermined distance from a customer job site.

3. The processor-readable medium of claim 2, wherein the information comprises information relating to the services that are offered by a service provider.

4. The processor-readable medium of claim 1, further comprising:
instructions for the processor to visually display information relating to pre-authorized service providers offering services that match the type of service requested provided in the service request.

5. The processor-readable medium of claim 1, further comprising:
instructions for the processor to receive service provider preference information from the customer, the service provider preference information comprising one or more qualities desired by the customer of the service provider who ultimately performs the service;
instructions for the processor to add the service provider preference information to the service request; and
instructions for the communication interface to transmit the service request to the central server.

6. The processor-readable medium of claim 1, further comprising:
instructions for the processor to receive service provider preference information from the customer, the service provider preference information comprising one or more qualities desired by the customer of the service provider who ultimately performs the service; and
instructions for the processor to display information relating to only pre-authorized service providers offering services that match the type of service requested from the customer and additionally meet the service provider preference information.

7. The processor-readable medium of claim 1, further comprising:
instructions for the processor to receive an invoice for services rendered, via the communication interface, from the central server, the invoice transmitted from a service provider that accepted the service request; and
instructions for the processor to provide the invoice to the display for viewing by the customer.

8. The processor-readable medium of claim 7, further comprising:
instructions for the processor to receive a selection from the customer of a payment method;
instructions for the processor to generate a payment message instructing the central server to have the invoice paid using the selected payment method; and
instructions for the communication interface to transmit the payment message.

11. The processor-readable medium of claim 1, further comprising:
instructions for the communication interface to receive a message from the central server indicating arrival of the service provider to a customer job site; and
instructions for providing an indication to the customer, via the user interface, that the service provider who accepted the service request has arrived at the customer job site.

12. A processor-readable medium having processor-executable instructions stored thereon for execution by a processor to perform a method for managing work flow for a pre-authorized service provider using a wireless communication device, comprising:
instruction for a communication interface in the wireless communication device to receive an invitation from a central server to provide a service requested by a customer;
instructions for a user interface on the wireless communication device to display the invitation to the service provider;
instructions for the processor to receive an indication of acceptance of the invitation from the service provider via a user interface;
instructions for the communication interface to transmit a response to the invitation accepting the invitation;
instructions for the processor to receive service material procurement information from the service provider, via the user interface, the material procurement information comprising a description and a cost of one or more items needed to perform the service;
instructions for the processor to store the material procurement information in a memory;
instructions for the processor to calculate a time that the service provider spent performing the service;
instructions for the processor to calculate an electronic invoice using the time that the service provider spent performing the service and the cost of each of the one or more items needed to perform the service; and
instructions for the communication interface to transmit the invoice to the central server for ultimate presentation of the invoice to the customer who requested the service via a customer wireless communication device.

13. The processor-readable medium of claim 12, further comprising:
instructions for the processor to provide a count-down timer to the user interface indicative of a time in which the service provider may accept the invitation; and
instructions for the processor to prevent acceptance of the invitation if the count-down timer has elapsed.

14. The processor-readable medium of claim 12, further comprising:
instructions for the communication interface to transmit identification information to the central server for registration with the central server; and
receiving authorization from the central server for the service provider to provide services to customers;
wherein the invitation to provide the service originates from a service request from only customers who have previously registered with the central server.

15. The processor-readable medium of claim 12, wherein the identification information comprises a digital image of a license held by the service provider, and the authorization from the central server is received only after the license has been validated by the central server.

16. The processor-readable medium of claim 12, further comprising:
instructions for the processor to receive a notification, via the communication interface, indicating that the invitation has been rescinded after a predetermined time period has elapsed.

17. The processor-readable medium of claim 12, wherein the invitation comprises a job site location, further comprising:
instructions for receiving an indication from the service provider, via the user interface, that the service provider is en route to a customer job site; and
instructions for the communication interface to transmit the indication to the central server.

18. The processor-readable medium of claim 12, wherein the invitation comprises a job site location, further comprising:
instructions for the processor to determine a present location of the wireless communication device;
instructions for the processor to determine an estimated time of arrival based on the present location of the wireless communication device and the job site location; and
instructions for the communication interface to transmit the estimated time of arrival to the central server.

19. A central server for managing work flow between a customer using a customer wireless communication device and a pre-authorized service provider using a service provider wireless communication device, comprising:
a network interface for transmitting to and receiving information from the customer and the service provider;
a memory for storing account information associated with the customer and the pre-authorized service provider and for storing processor-executable instructions;
a processor for executing the processor-executable instructions that cause the central server to:
receive a service request from the customer;
generate an invitation to provide a service to the customer based on the service request;
send the invitation to one or more pre-authorized service providers, including the pre-authorized service provider, each of the pre-authorized service providers previously having registered with the central server;
receive an acceptance to the invitation from the pre-authorized service provider;
receive invoice information from the service provider after the service has been completed; and
provide the invoice information to the customer after the service provider has provided the service to the customer.

20. The central server of claim 19, wherein the instructions that cause the central server to send the invitation to one or more pre-authorized service providers comprises instructions that cause the central server to:
send the invitation to a first pre-authorized service provider;
wait for a predetermined time period for an acceptance of the invitation from the first service provider; and
if no response is received from the first service provider within the predetermined time period:
a) revoke the invitation from the first service provider;
b) send the invitation to a second service provider;
c) repeat steps a) and b), above, until an acceptance of the invitation from one of the pre-authorized service providers.

21. The central server of claim 19, wherein the service request comprises an indication of a job site where the customer would like the service performed, wherein the processor-executable instructions further comprise instructions that cause the central server to:
receive location information from one or more authorized service providers;
determine which of the authorized service providers is closest to the job site;
send the invitation to the authorized service provider that is closest to the job site;
if no response is received from the service provider closest to the job site within a predetermined time period determine the next-closest authorized service provider to the job site; and
send the invitation to the next-closest authorized service provider.

22. The central server of claim 19 wherein the processor-executable instructions further comprise instructions that cause the central server to:
receive a status update from at least one of the authorized service providers;
send a list of available service providers to the customer wireless communication device

23. The central server of claim 19, further comprising processor-executable instructions that cause the central server to:
receive a registration request from a first un-authorized service provider who has not previously registered with the central server, the registration request comprising information relating to the first un-authorized service provider;
verify that at least some of the information is accurate; and
if the information is accurate:
create an account on behalf of the first un-authorized service provider comprising at least some of the information;
store the account in the memory; and
send a message to the un-authorized service provider indicating that the un-authorized service provider is now an authorized service provider.
